(19) United States
(12) Patent Application Publication
(10) Pub. No.: US 2018/0099599 A1
(43) Pub. Date: Apr. 12, 2018

(54) Vent Caddy

(71) Applicants: Stephen Gerard Karrer, E. Rutherford, NJ (US); Jeffrey Cartagena, Union City, NJ (US)

(72) Inventors: Stephen Gerard Karrer, E. Rutherford, NJ (US); Jeffrey Cartagena, Union City, NJ (US)

(21) Appl. No.: 15/728,132

(22) Filed: Oct. 9, 2017

Related U.S. Application Data
(60) Provisional application No. 62/405,902, filed on Oct. 8, 2016.

(51) Int. Cl. B60N 3/10; B60H 1/00

(52) U.S. Cl. CPC B60N 3/104; B60H 1/00592; B60N 3/108; B60N 3/103; B60N 3/102

(57) ABSTRACT

Disclosed is a vent caddy for securely holding an item that a user desires to have an ambient temperature around the item be regulated by utilizing a vehicle's ventilation system. The vent caddy comprises an outer box and an airflow intake. The outer box comprises an interior chamber. The airflow intake is in communication with the vehicle's ventilation system. The airflow intake is in communication with the interior chamber. Conditioned air flows from the vehicle's ventilation system through the airflow intake to the interior chamber. The interior chamber is configured to securely hold the items. The conditioned air regulates the ambient air surrounding the item.

### CROSS-REFERENCE TO RELATED APPLICATIONS

The present application claims priority to provisional U.S. patent application Ser. No. 62/405,902, filed Oct. 8, 2016 and entitled “Vent Caddy,” the disclosure of which is incorporated herein by reference in its entirety.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The present invention relates to a vent caddy system for use in a vehicle and utilizing a vehicle's ventilation system for efficient cooling and warming of various items. While traveling in various vehicles, a need exists to cool, or to maintain at temperatures lower than the vehicles' ambient temperatures, various items, such as beverages, foodstuffs, personal belongings, and other items. A need also exists for various such items to be warmed, or maintained at temperatures higher than the vehicles' ambient temperatures. Further, it is desirable that the items be secured within the vehicle while the items are being cooled or heated to avoid spillage, loss, breakage or excessive shaking. Also, a person traveling in the vehicle needs to be able to easily remove items from the vent caddy when desired, or to place items in the vent caddy when cooling or heating of those items is desired.

The vent caddy can hold various beverages (e.g., water, juice, tea, coffee), snacks (e.g., chocolate, pastries, donuts, croissants), dairy products (e.g., milk, baby bottles), sandwiches, and other consumable products that may need to be cooled, warmed, or maintained at temperatures that are lower or higher than the vehicles' ambient temperatures. For example users can purchase room temperature croissants and warm them while driving. Users can also purchase room temperature beverages and cool them to a comfortable drinking temperature while driving or riding in a vehicle.

### BRIEF SUMMARY OF THE INVENTION

An object of present invention is to provide a vent caddy that utilizes a vehicle's ventilation system to efficiently cool, warm, or maintain at temperatures different from the vehicle's ambient temperature, various items, such as beverages, foodstuffs, and other personal items. A further object of the present invention is to provide a vent caddy that securely holds the items within the vehicle to avoid rolling, displacement, excessive shaking, or excessive vibration. An even further object of this invention is to provide a vent caddy that enables a user to easily place items in the vent caddy or remove items from the vent caddy. The vent caddy can utilize vents located on a vehicle's dashboard, or located in the rear seat area, overhead area, headliner area, trunk area, glovebox, feet area, and others.

In testing, the vent caddy reduced the temperature of water from 103 F to 73 F in just 10 minutes. After 20 minutes in the vent caddy, the water was “ice cold.” This was proven to be highly useful for car service drivers as they need to cool beverages on demand for their passengers.

Another object of the present invention is a vent caddy that securely holds various items and utilizes a vehicle's ventilation system to cool, warm, or maintain at temperatures different from the vehicle's ambient temperature, the various items, the vent caddy comprising an outer box, an airflow intake, a dashboard seal, an interior chamber, a contents securing instrument, an airflow escape, a secondary chamber, a plurality of utility compartments, and, a holding and positioning arm. The vent caddy of may further comprise a covering.

Yet another object of the present invention is a vent caddy for securely holding an item that a user desires to have an ambient temperature around the item be regulated by utilizing a vehicle's ventilation system. The vent caddy comprises an outer box and an airflow intake. The outer box comprises an interior chamber. The airflow intake is in communication with the vehicle's ventilation system. The airflow intake is in communication with the interior chamber. Conditioned air flows from the vehicle's ventilation system through the airflow intake to the interior chamber. The interior chamber is configured to securely hold the items. The conditioned air regulates the ambient air surrounding the item.

Another object of the present invention is a vent caddy further comprising a dashboard seal, wherein the dashboard seal forms a seal between the airflow intake and the vehicle's ventilation system.

Yet another object of the present invention is a vent caddy further comprising a contents securing instrument.

Another object of the present invention is a vent caddy further comprising an airflow escape, wherein the airflow escape is in communication with the interior chamber; and, wherein the conditioned air flows from the interior chamber through the airflow escape.

Yet another object of the present invention is a vent caddy further comprising a secondary chamber. The secondary chamber comprises an aperture; wherein the aperture is in communication with the airflow escape; and, wherein the conditioned air flows into the secondary chamber.

Another object of the present invention is a vent caddy further comprising a covering.

Yet another object of the present invention is a vent caddy further comprising a plurality of utility compartments.

Another object of the present invention is a vent caddy of claim 1 further comprising a holding and positioning arm; wherein the holding and positioning arm comprises an anchor and an adjustable rod.

Yet another object of the present invention is a vent caddy wherein the interior chamber is integrally formed with the outer box.

Another object of the present invention is a vent caddy wherein the interior chamber is removably inserted into the outer box.

Yet another object of the present invention is a vent caddy wherein the outer box further comprises a tether and a sleeve. The tether is removably attached to an inside surface of the outer box. The sleeve is attached to the teether.

Another object of the present invention is a vent caddy wherein the outer box further comprises a reservoir.

### BRIEF DESCRIPTION OF THE SEVERAL VIEWS OF THE DRAWING

The advantages and features of the present invention will be better understood as the following description is read in conjunction with the accompanying drawings, wherein:

FIG. 1 is a front elevational view of an embodiment of the vent caddy.

FIG. 2 is a perspective view of an embodiment of the vent caddy.

FIG. 3 is a left elevational view of an embodiment of the vent caddy.

FIG. 4 is a perspective view of an embodiment of the vent caddy.

FIG. 5 is another perspective view of an embodiment of the vent caddy.

FIG. 6 is another perspective view of an embodiment of the vent caddy without a secondary chamber.

FIG. 7 is a front elevational view of an embodiment of the vent caddy without a secondary chamber.

FIG. 8 is a top plan view of an embodiment of the vent caddy without a secondary chamber.

FIG. 9 is another perspective view of an embodiment of the vent caddy without a secondary chamber.

FIG. 10 is an exploded view of an embodiment of the vent caddy.

FIG. 11 is another exploded view of an embodiment of the vent caddy.

FIG. 12 is another exploded view of an embodiment of the vent caddy.

FIG. 13 is another exploded view of an embodiment of the vent caddy without a secondary chamber.

FIG. 14 is another exploded view of an embodiment of the vent caddy without a secondary chamber.

FIG. 15 is another exploded view of an embodiment of the vent caddy without a secondary chamber.

FIG. 16 is another perspective view of an embodiment of the vent caddy.

FIG. 17 is an image of a prototype of an embodiment of the vent caddy.

FIG. 18 is an image of a prototype of an embodiment of the vent caddy.

FIG. 19 is an image of a prototype of an embodiment of the vent caddy.

FIG. 20 is an image of a prototype of an embodiment of the vent caddy.

FIG. 21 is an image of a prototype of an embodiment of the vent caddy.

FIG. 22 is a front view of an embodiment of the vent caddy.

### DETAILED DESCRIPTION OF THE INVENTION

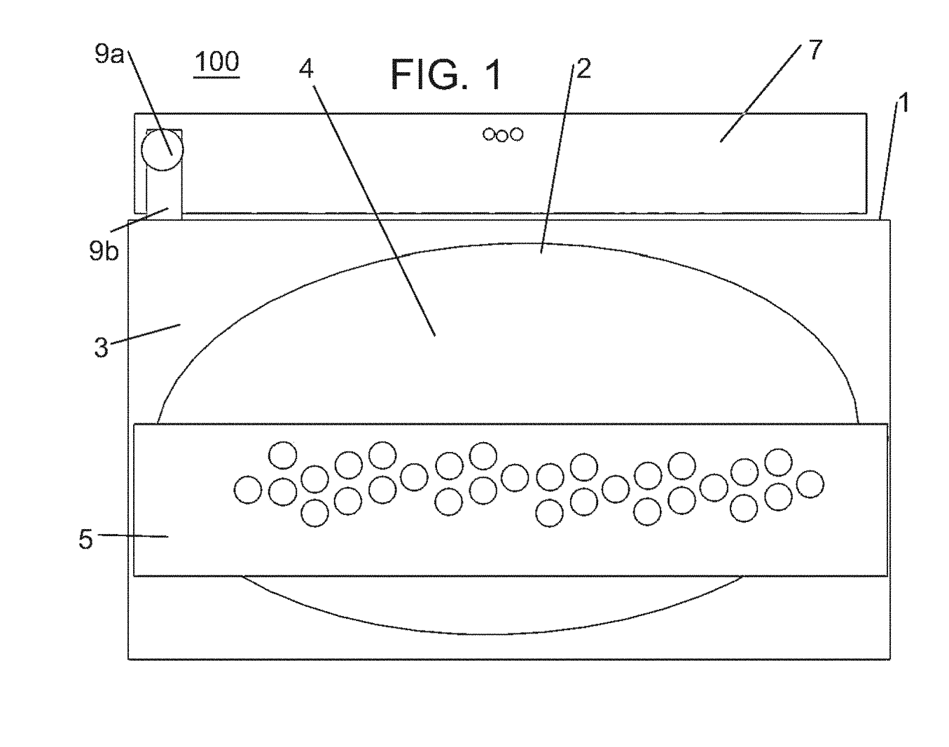

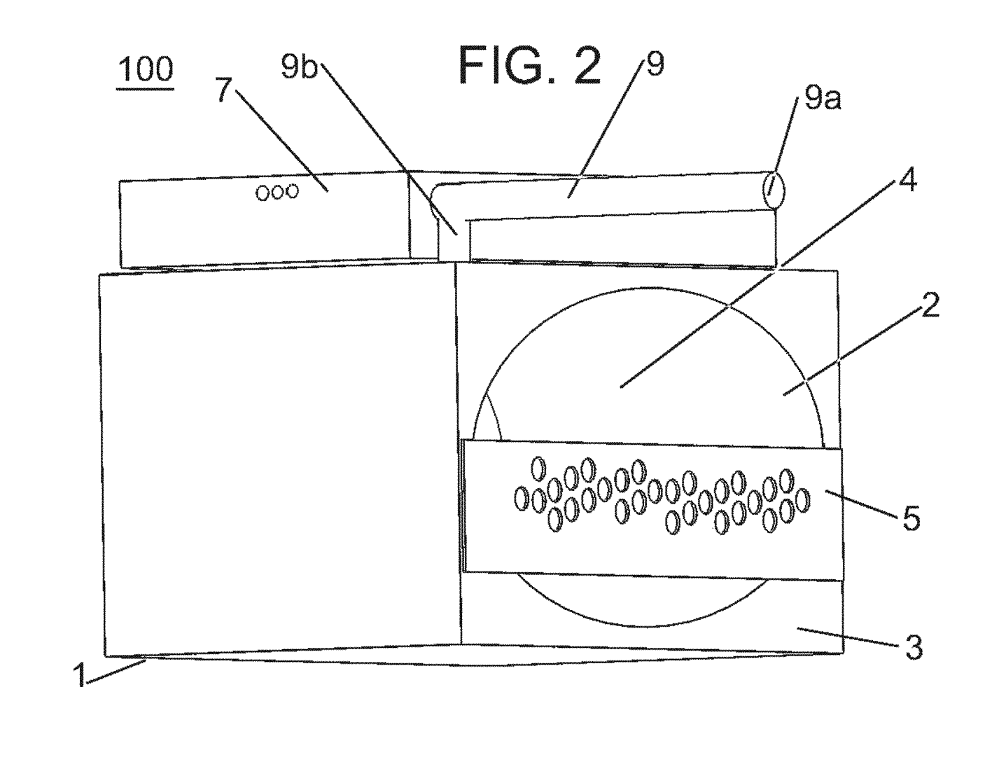

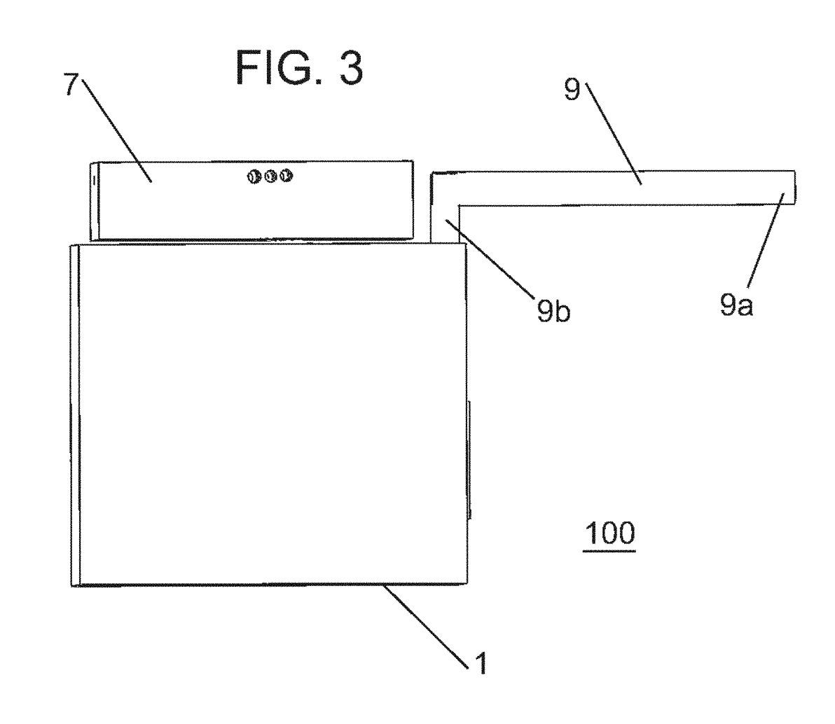

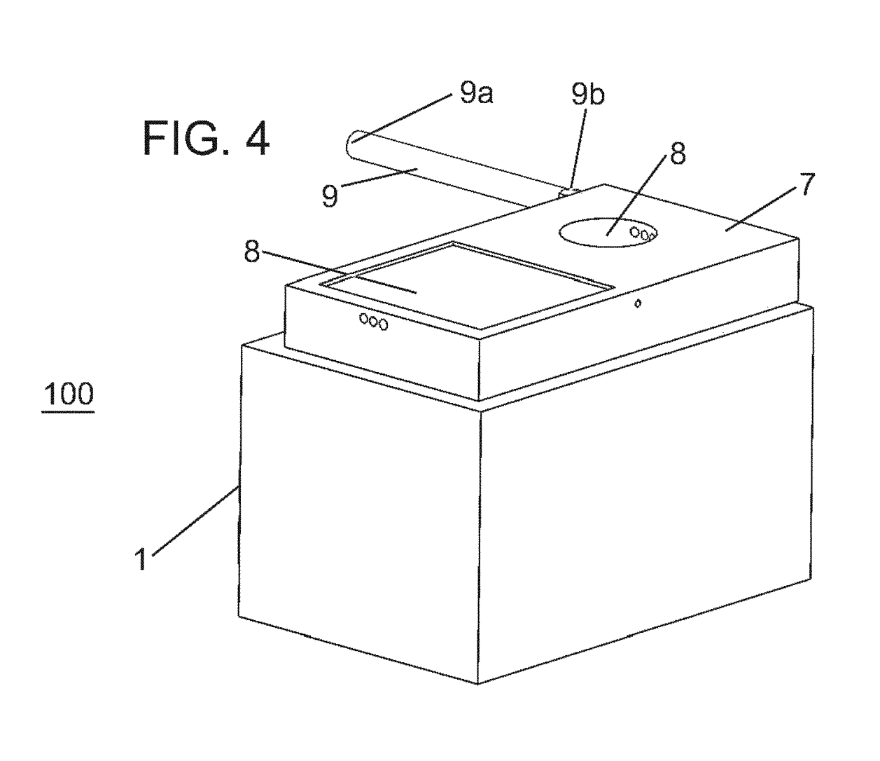

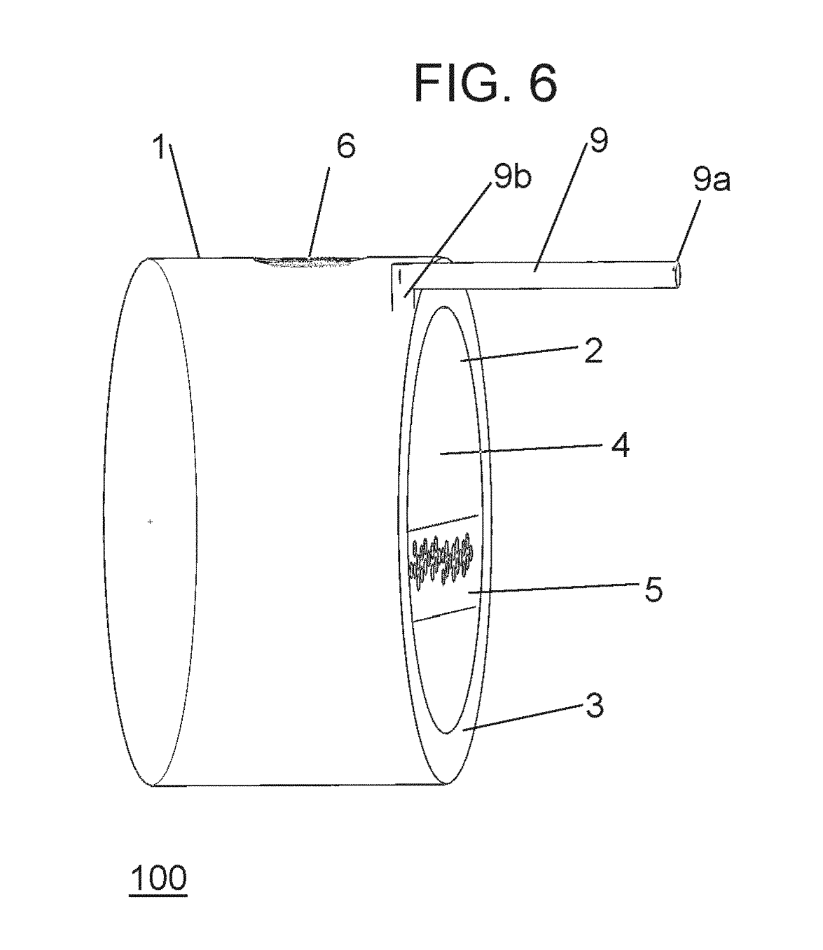

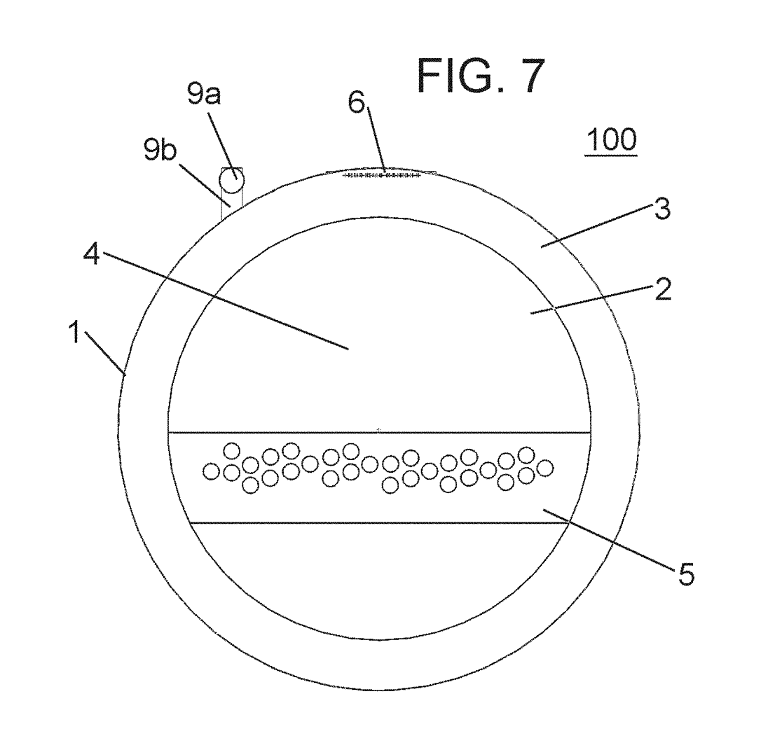

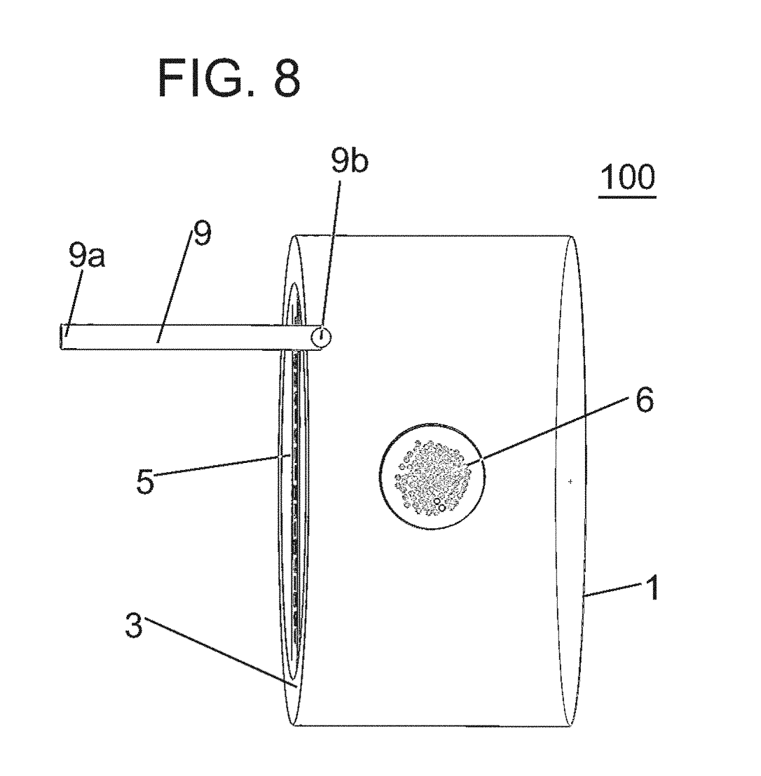

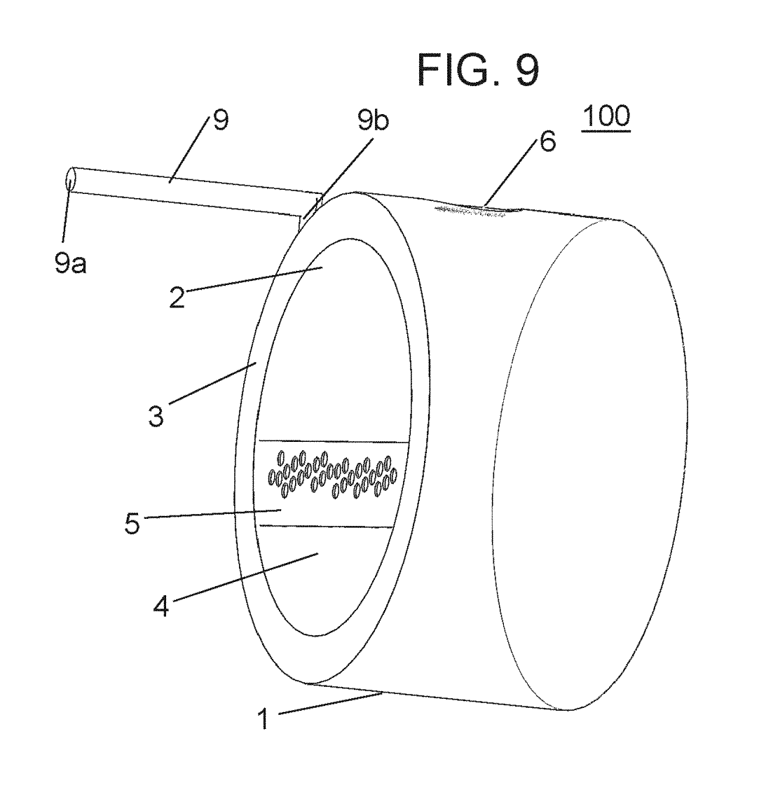

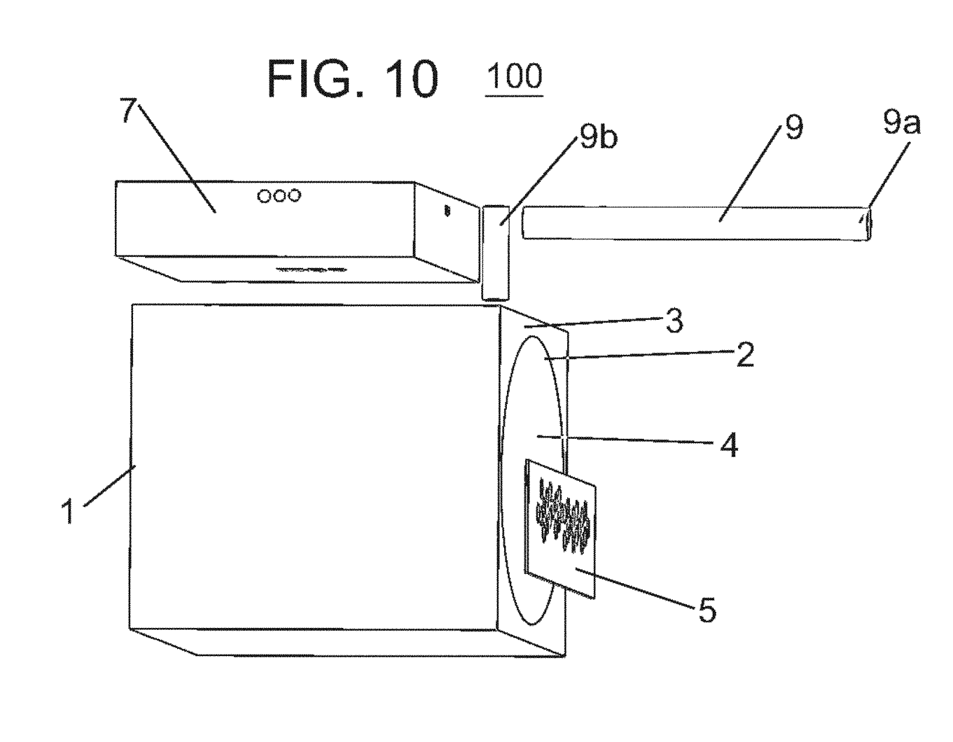

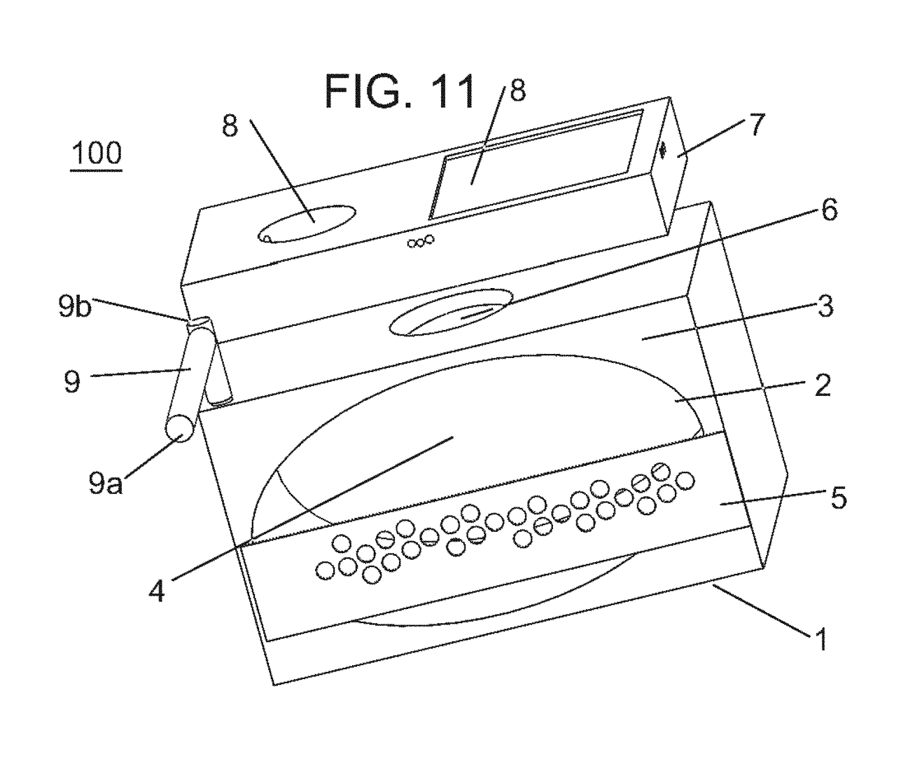

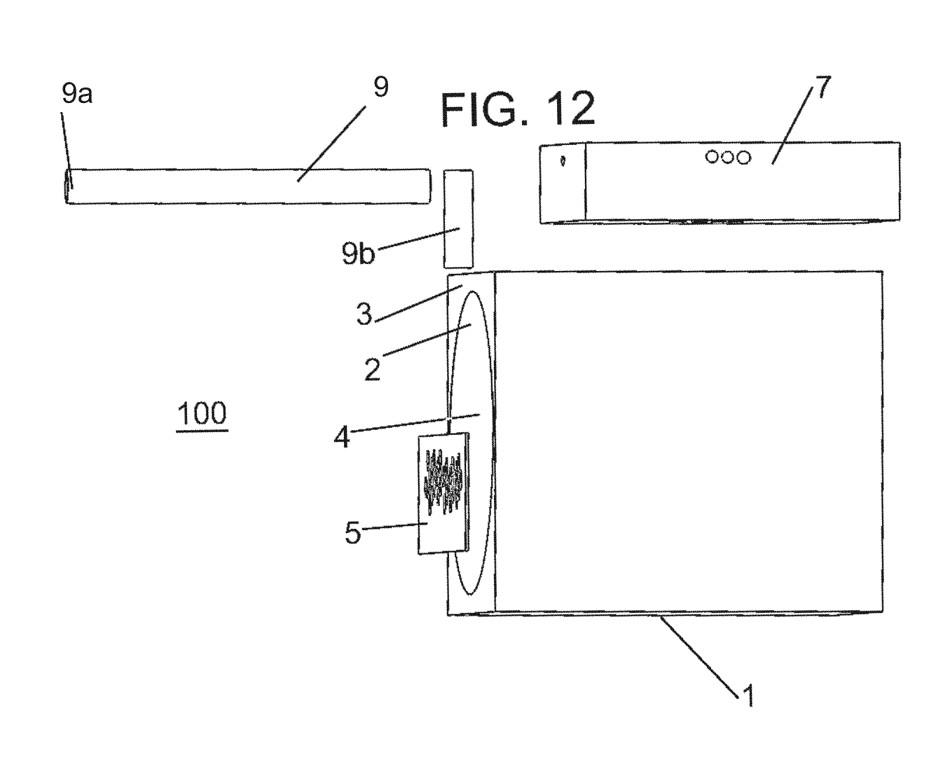

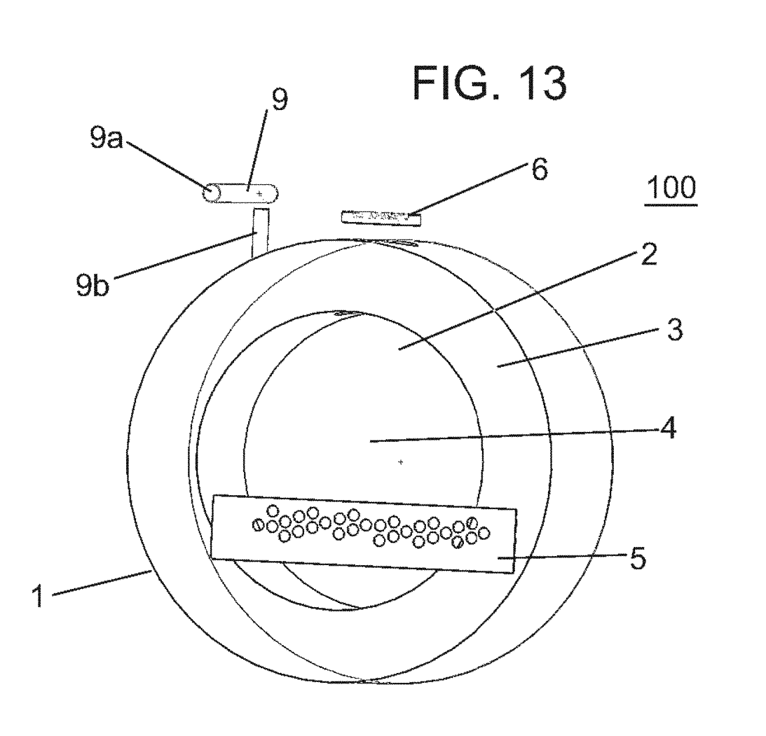

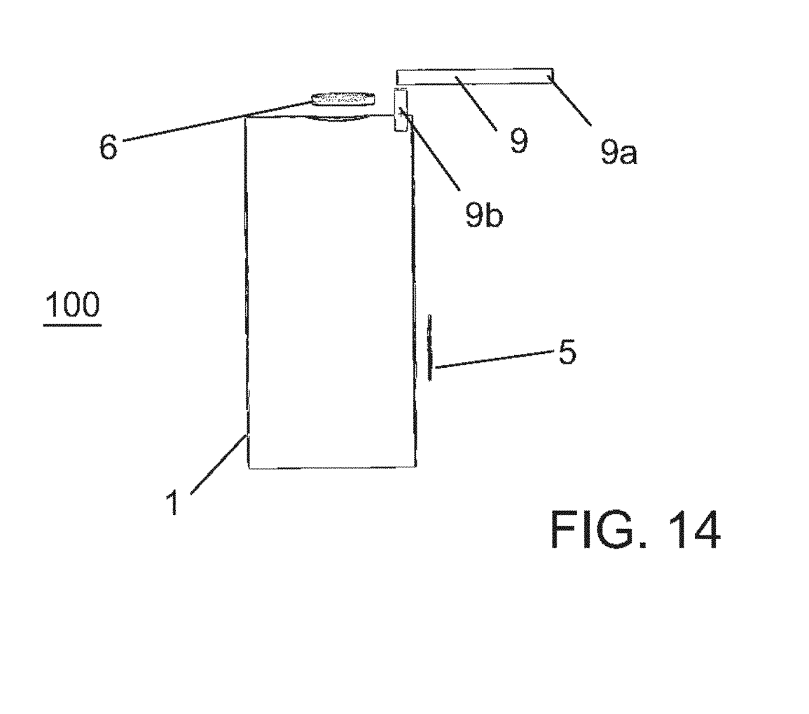

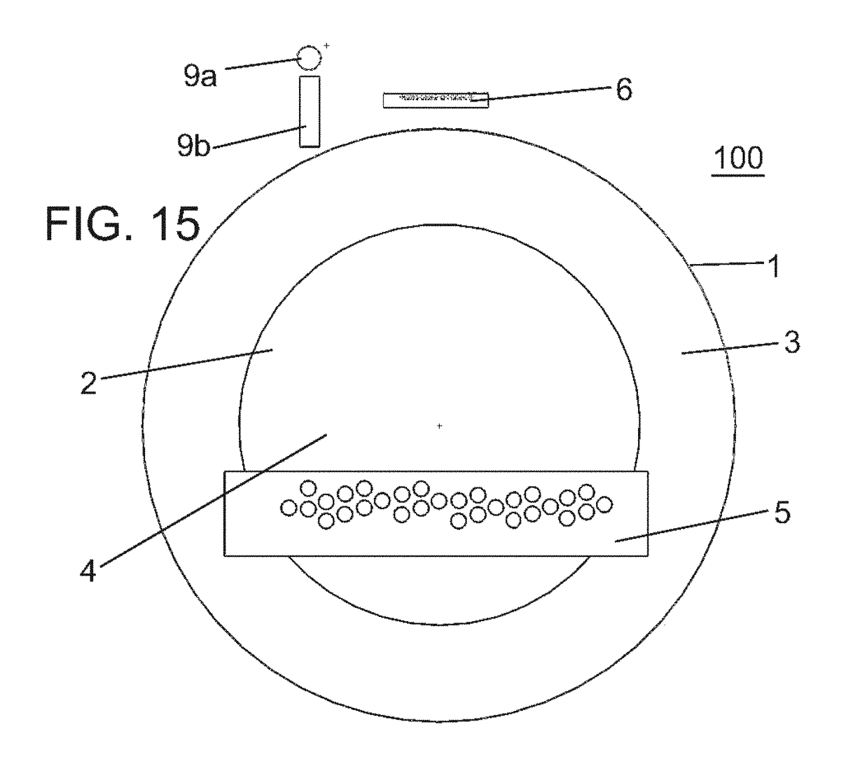

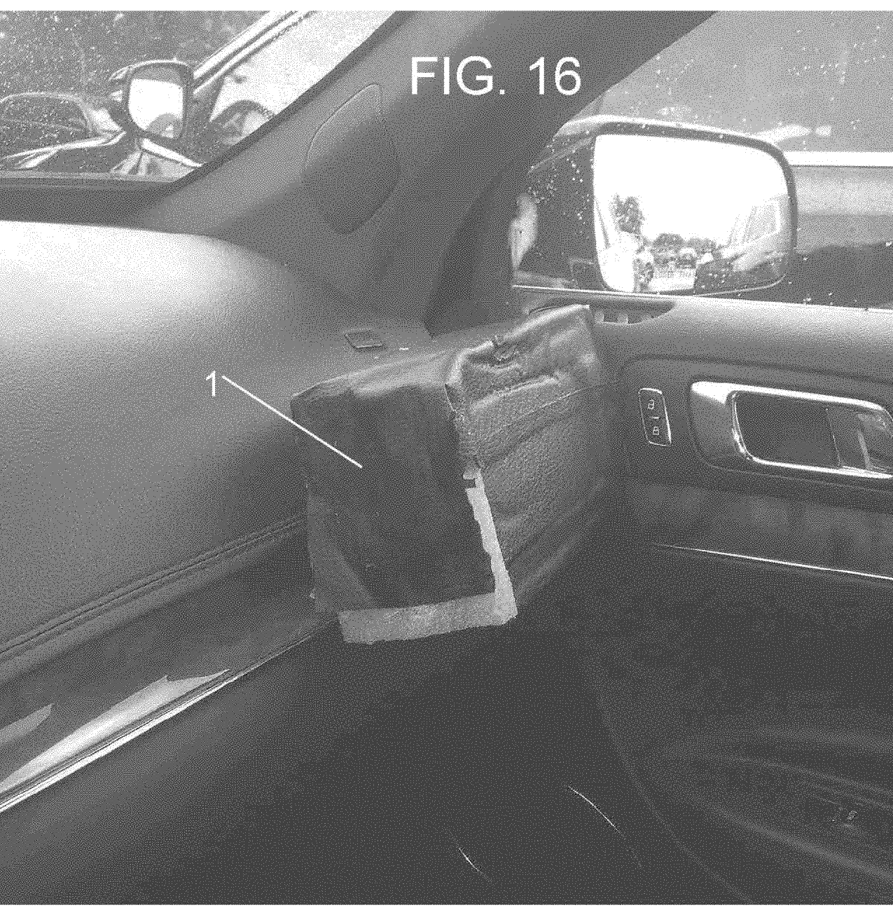

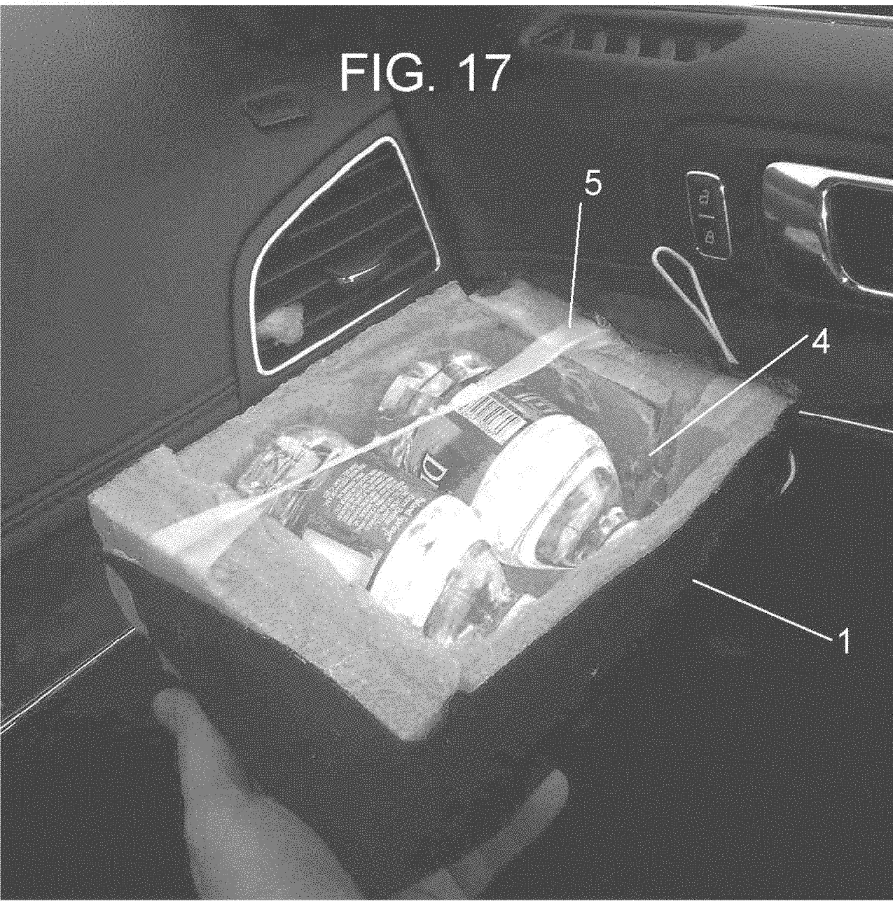

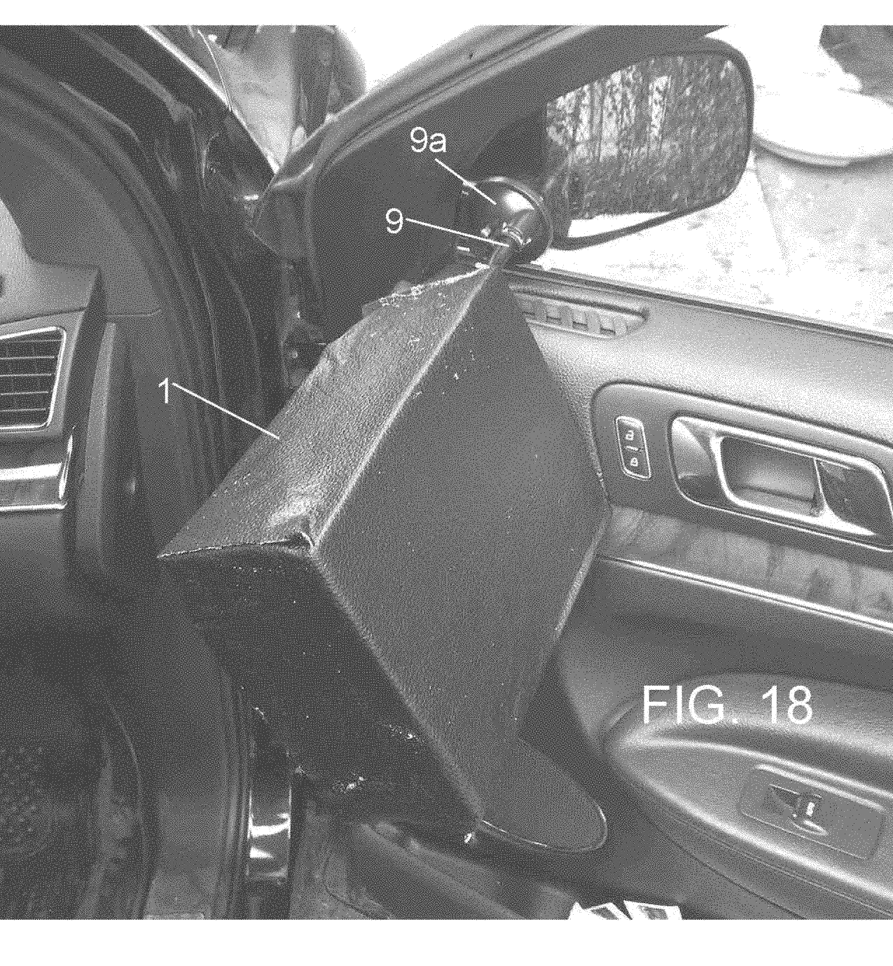

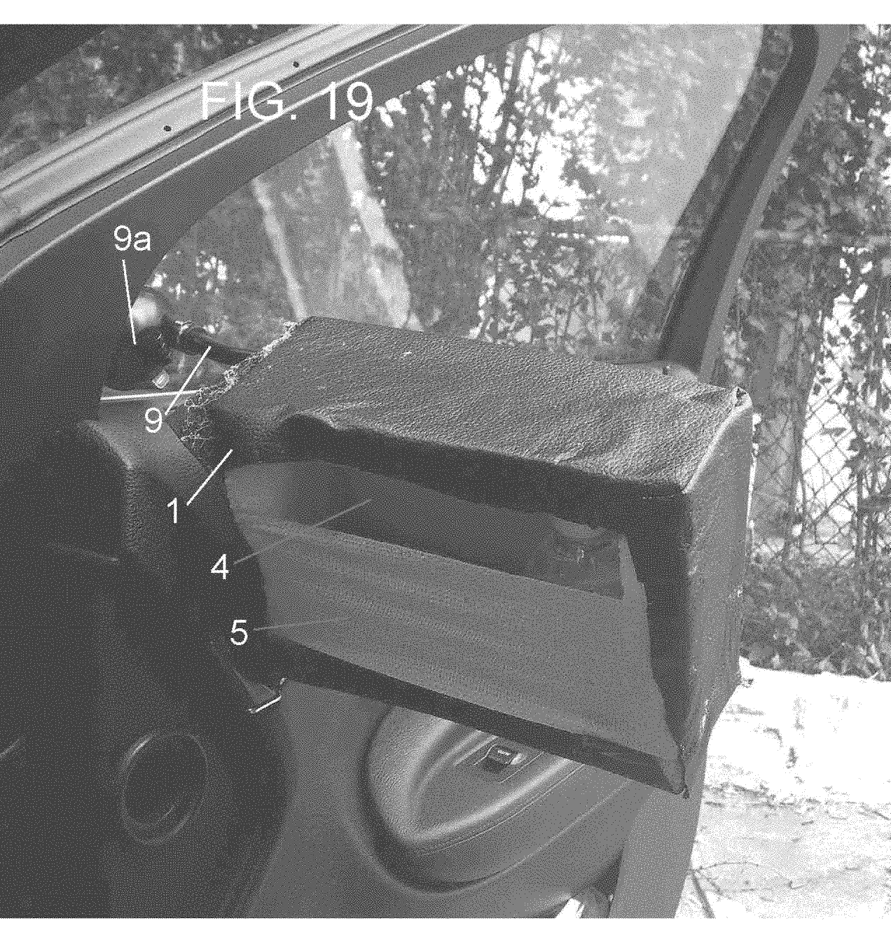

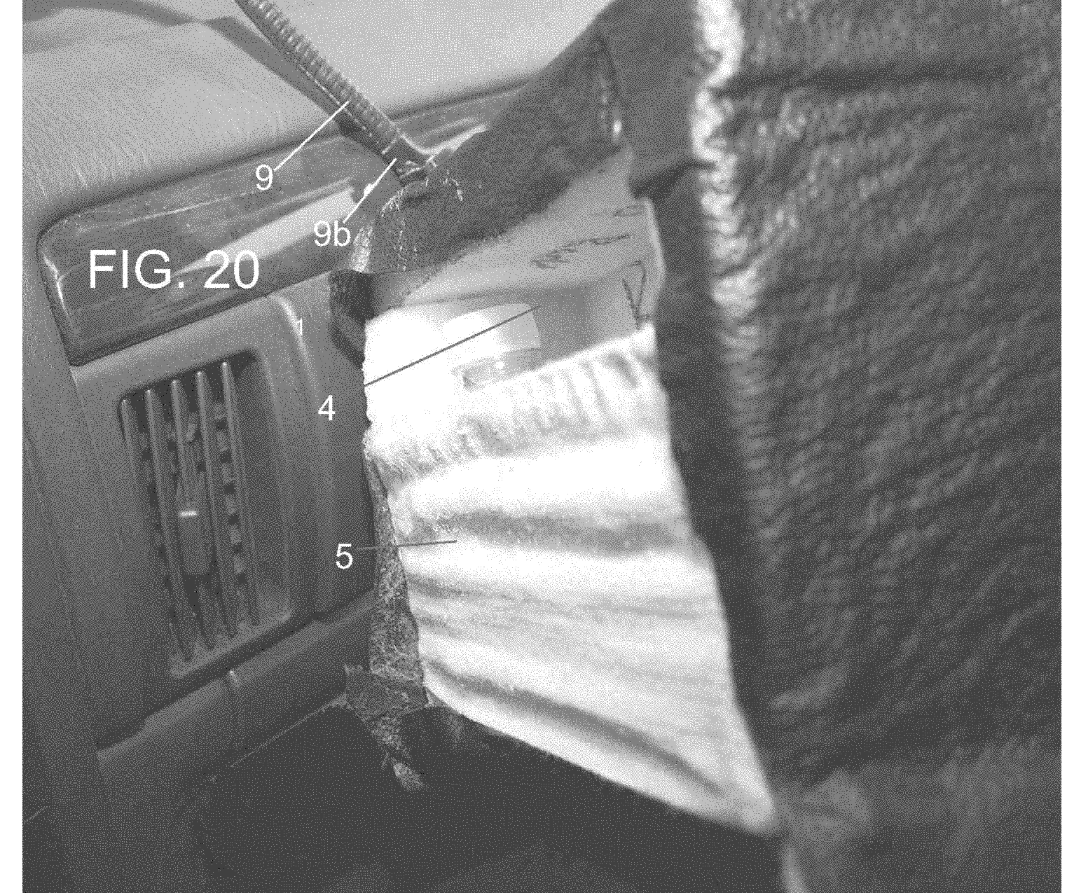

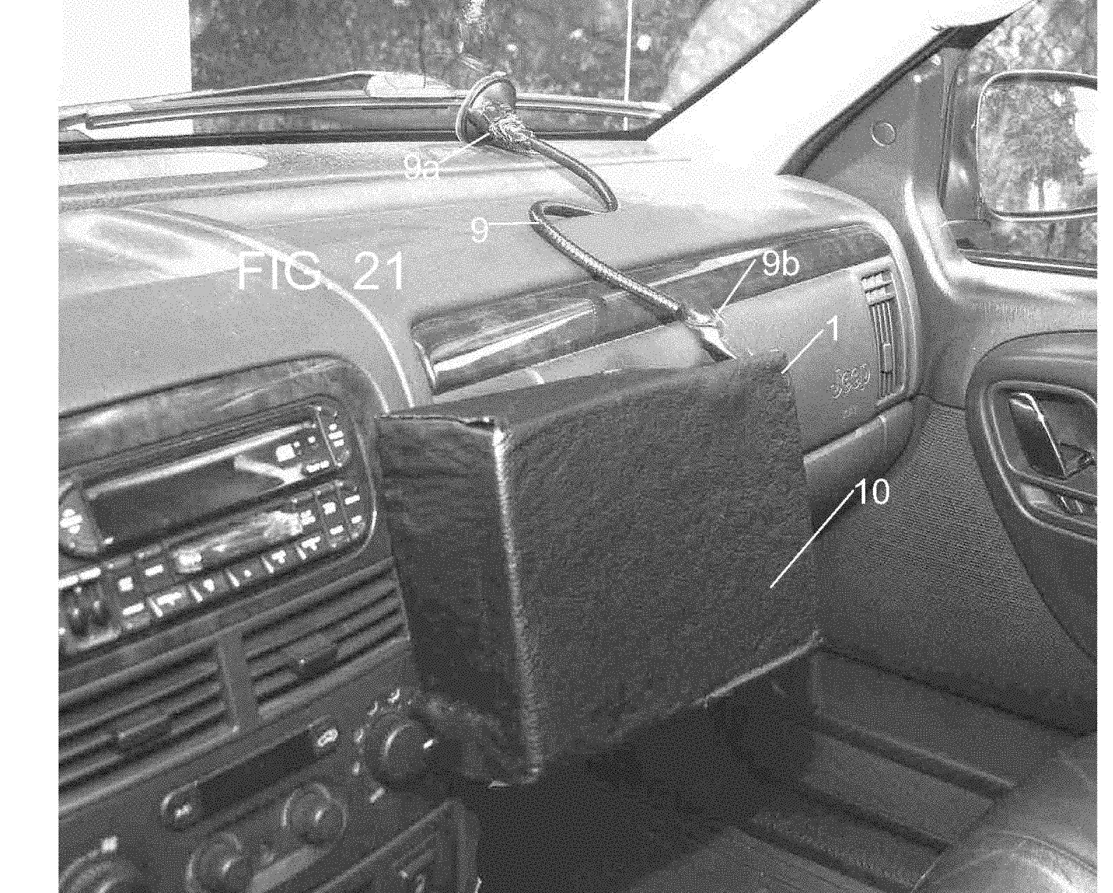

FIGS. 1-5 and 10-12 illustrate various embodiments of the present invention, a vent caddy 100 that securely holds various items and utilizes a vehicle's ventilation system to cool, warm, or maintain at temperatures different from the vehicle's ambient temperature, the various items, the vent caddy 100 comprising: an outer box 1, an airflow intake 2, a dashboard seal 3, an interior chamber 4, a contents securing instrument 5, an airflow escape 6, a secondary chamber 7, a plurality of utility compartments 8, and, a holding and positioning arm 9. The vent caddy may further comprise a covering 10, an anchor 9a and an adjustable rod 9b. FIGS. 6-9 and 13-21 illustrate various embodiments of a vent caddy 100 without a secondary chamber 7. For clarity purposes, not all of the reference numerals are included in every figure.

In one embodiment, the vent caddy 100 is secured against a vehicle dashboard in a position allowing air from a dashboard vent to fill the interior chamber 4 with hot or cold air through the airflow intake 2. The dashboard seal 3 forms a seal between the dashboard and the vent caddy 100 thus preventing most of the hot or cold air from the dashboard vent from escaping into the vehicle and ensuring that the hot or cold air enters the interior chamber 4 and remains in prolonged contact with the contents of the interior chamber 4 to efficiently cool them or warm them. The insulation of the vent caddy 100 minimizes the heat exchange with the ambient air of the vehicle further increasing the efficiency of the heating or cooling. The combination of the dashboard seal 3 and the insulation of the vent caddy 100 allows the vent caddy 100 to efficiently cool, warm or maintain the temperature of the interior chamber 4 even when the airflow from the dashboard vent is much lower than would be necessary to cool or warm an item by positioning and holding the item in front of the dashboard vent by hand or other device. As the air inside the interior chamber 4 is warmed or cooled by the contents of the interior chamber 4, the air escapes through the air escape 6 and is replaced with new cold or warm air from the dashboard vent through the airflow intake 2.

The outer box 1 is the main body of the vent caddy 100. All other parts of the vent caddy 100 either connect to or are contained within the outer box 1. It is preferred that the outer box 1 be structurally rigid.

The outer box 1 can be made of different types of materials or a combination of different types of materials including; rubber, foam, plastic, plexiglass, wood, aluminum, Polyvinyl chloride, polypropylene, polyethylene, SAN resin, ceramics, metal, wood, plastic, composite, fiberglass, corrugated, graphite, plexiglass, among other materials. In addition, the outer box 1 may be constructed from or include insulating materials, such as various types of foam including polyethylene foam, polypropylene foam, polystyrene foam, dry fast foam, closed cell foam, memory foam, rebond foam, supreem foam, latex rubber foam, high resilience foam, evlon foam, or high density foam.

The outer box 1 can be of various shapes, including prism, rectangular prism, cylinder, cube, sphere or portion of a sphere, or any other geometric shape.

The outer box 1 can include an electrical power circuit for providing electric power for a fan, peltier chip, heating element, or other devices requiring electricity. The electrical power circuit may comprise an appropriately positioned solar panel, a compartment for batteries, or a circuit for connecting to the vehicle electrical system.

The outer box 1 also can include a slot or other compartments for ice, dry ice, heating or cooling packs, or similar substance for releasing cold or warm air into the interior chamber 4. The slots or compartments can be attached, either permanently or removably, to the inside or outside of the outer box 1. Preferably openings on the interior chamber 4 walls should be provided to allow airflow between the interior of the interior chamber 4 and the cooling or warming substances inside the slots or compartments. The forced airflow inside the interior chamber 4 from the dashboard vent will pull air through the openings and thus provide circulation of air between the interior chamber 4 and the slots or compartment. Alternatively in another embodiment, air circulation may be facilitated using a fan positioned on the outer box 4, in the interior chamber 4, or in the compartments or slots.

Preferably, the outer box 1 also provides an opening through which the interior chamber 4 can be inserted inside the outer box 1 or removed from the outer box 1, if the interior chamber 4 is removable. The opening may occupy the entire surface of one side of the outer box 1, in which case the cover of the opening will be the wall of the outer box 1. An opening to remove or insert the interior chamber 4 is not necessary if the interior chamber 4 is permanently attached to the outer box 1 and thus is not removable, or if the interior chamber 4 is formed by the inside insulation of the outer box 1, and thus an integral part of the outer box 1.

Preferably the outer box 1 also comprises an opening for accessing the contents of the vent caddy 100. That opening may be the same as the airflow intake 2 as explained below, or may be the same opening that is used to insert the interior chamber 4 into the outer box 1. In the alternative, the opening to access the contents of the vent caddy 100 may not be aligned with the airflow intake 2 and may be positioned on any wall of the outer box 1, preferably with a removable cover, preferably made from the same material as the outer box 1. It is also possible to not provide an additional opening for accessing the contents of the vent caddy 100 if the interior chamber 4 is removable, in which case the user will access the contents by removing the interior chamber 4 from the outer box 1.

The airflow intake 2 allows air from the vehicle's ventilation system to enter the interior chamber 4. The airflow intake 2 is the part that is closest to, in contact with or inside the vehicle's ventilation duct. The airflow intake 2 may simply be an opening in the outer box 1 wall closest to surface on which the vehicle vent is located. The airflow intake 2 may also be an additional component that attaches to the outer box 1, and aligns with an opening on the outer box 1, to accommodate different vehicle vents, including valves, gaskets, plates with differently shaped openings, tubes that insert in the vehicle ventilation duct and any combination of those.

The airflow intake 2 can have any shape, including being round, square, cylindrical, rectangular or any geometric shape. The airflow intake 2 may also be custom made to the shape of the vehicle vent that is being used by the vent caddy 100. A vent caddy 100 may also be provided with multiple air intakes 2 to accommodate different positions, vehicles, or vents. The airflow intake 2 can be made of different types of foam or a combination of different types of foam, including; polyethylene foam, polypropylene foam, polystyrene foam, dry fast foam, closed cell foam, memory foam, rebond foam, supreem foam, latex rubber foam, high resilience foam, evlon foam, or high density foam. The airflow intake 2 can be made of different types of materials or a combination of different types of materials including; rubber, foam, plastic, plexiglass, wood, aluminum, Polyvinyl chloride, polypropylene, polyethylene, SAN resin, ceramics, metal, wood, plastic, composite, fiberglass, corrugated, graphite, plexiglass, among other materials.

The airflow intake 2 can be either glued, adhered or melted to the outer box 1 or can be one solid part of the outer box 1. The airflow intake 2 can include an extension or attachment for connecting directly into a vehicle's ventilation duct. Alternatively, the airflow intake 2 can include an extension tube to allow the device to be position farther away from a ventilation duct.

In one embodiment the airflow intake 2 is large enough to also serve as the opening through which the contents of the vent caddy 100 can be accessed.

The dashboard seal 3 creates a secure fit with the vehicle ventilation system. The dashboard seal 3 is attached to the outer box 1 wall on which the air intake 2 is located and surrounds the air intake 2. The dashboard seal 3 can cover the entire wall of the outer box 1 or just a small portion of the area surrounding the air intake 2. Preferably the thickness of the dashboard seal 3 is from several millimeters to several centimeters and is constructed from pliable, insulating material so that when the outer box 1 is positioned and pressed against the dashboard, the dashboard seal 3 compresses and molds to the dashboard to provide a secure fit between the outer box 1 wall and the dashboard. Even though this embodiment is described with respect to a dashboard vent, it should be understood that the dashboard seal 3 may be used to provide a tight fit between the outer box 1 wall containing the air intake 2 and any surface on which a vent is located. The dashboard seal 3 may also extend outward to provide a seal with a vent instead of with the surface surrounding the vent.

The dashboard seal 3 can be round, square, cylindrical, rectangular or any geometric shape for optimizing airflow and thermodynamics. The dashboard seal 3 can be made of different types of rubber, resins, or foam or a combination of different types of foam, including; polyethylene foam, polypropylene foam, polystyrene foam, dry fast foam, closed cell foam, memory foam, rebond foam, supreem foam, latex rubber foam, high resilience foam, evlon foam, or high density foam. The dashboard seal 3 may also contain different types of materials if necessary including; rubber, foam, plastic, plexiglass, wood, aluminum, Polyvinyl chloride, polypropylene, polyethylene, SAN resin, ceramics, metal, wood, plastic, composite, fiberglass, corrugated, graphite, plexiglass, among other materials.

The dashboard seal 3 may be glued, adhered or melted to the outer box 1 or can be one solid part of the outer box 1. The dashboard seal 3 can be either glued, adhered or melted to the airflow intake 2 or can be an integral part of the airflow intake 2.

The dashboard seal 3 may also have an adhesive surface to adhere to the dashboard, or any surface surrounding a vehicle vent. The adhesive may be used to increase the tightness of the fit between the outer box 1 and the dashboard, or to support the outer box 1 and thus eliminate the need for the holding and positioning arm 9.

The interior chamber 4 is where the items are placed to be cooled or warmed by the cold or hot air circulating around the items inside the interior chamber 4. The interior chamber 4 is the insulator of the vent caddy 100. The interior chamber 4 is enclosed on all six sides, with the exception of the openings explained below, thus allowing the air from the vehicle vent to remain in the interior chamber 4 and prolonging the contact with the contents of the interior chamber 4, providing for efficient cooling or warming of the contents.

The interior chamber 4 can be a removable part of the vent caddy 100 or permanently attached to the outer box 1. The interior chamber 4 may also be an integral part of the outer box 1, for example when the interior chamber 4 is formed by the inside wall surface of the outer box 1. The interior chamber 4 may also be made from microwavable or heat resistant material so that its contents can be warmed using an appliance such as on stove, burner, oven, microwave oven or similar. The interior chamber 4 may also be made of material that can be put in a freezer or refrigerator to cool the contents of the interior chamber 4 before placing in the outer box 1 and in a vehicle.

The interior chamber 4 can be round, square, cylindrical, rectangular or any geometric shape for optimizing airflow and thermodynamics. The interior chamber 4 can be made of different types of foam or a combination of different types of foam, including; polyethylene foam, polypropylene foam, polystyrene foam, dry fast foam, closed cell foam, memory foam, rebond foam, supreem foam, latex rubber foam, high resilience foam, evlon foam, or high density foam. The interior chamber 4 can be made of different types of materials or a combination of different types of materials including; rubber, foam, plastic, plexiglass, wood, aluminum, Polyvinyl chloride, polypropylene, polyethylene, SAN resin, ceramics, metal, wood, plastic, composite, fiberglass, corrugated, graphite, plexiglass, among other materials.

The interior chamber 4 can be either glued, adhered or melted to the outer box 1 or can be integral part of the outer box 1. The interior chamber 4 can include a thermo gel for keeping the temperature stable when vehicle's ventilation system is off.

The interior chamber 4 may include a “seesaw” or a rocking mechanism to slowly rock beverages inside the interior chamber 4 and mix the liquid inside the beverage containers to enhance the cooling or warming effect by slowly replacing the cooled or warmed fluid near the beverage container wall with liquid from the inside of the beverage container. In its simplest form the rocking mechanism comprises a platform inside the interior chamber 4 that that is movably attached with hinges to a cylindrical rod running along the centerline of the platform. The cylindrical rod is attached to the bottom inside surface of the interior chamber 4 and is positioned between the bottom surface of the interior chamber 4 and the platform, raising the platform from the bottom surface and allowing it to rock or see-saw as the vehicle moves or turn. The “seesaw mechanism” may also include a locking mechanism to lock it and prevent rocking movement when desired, for example when cooling or heating carbonated beverages.

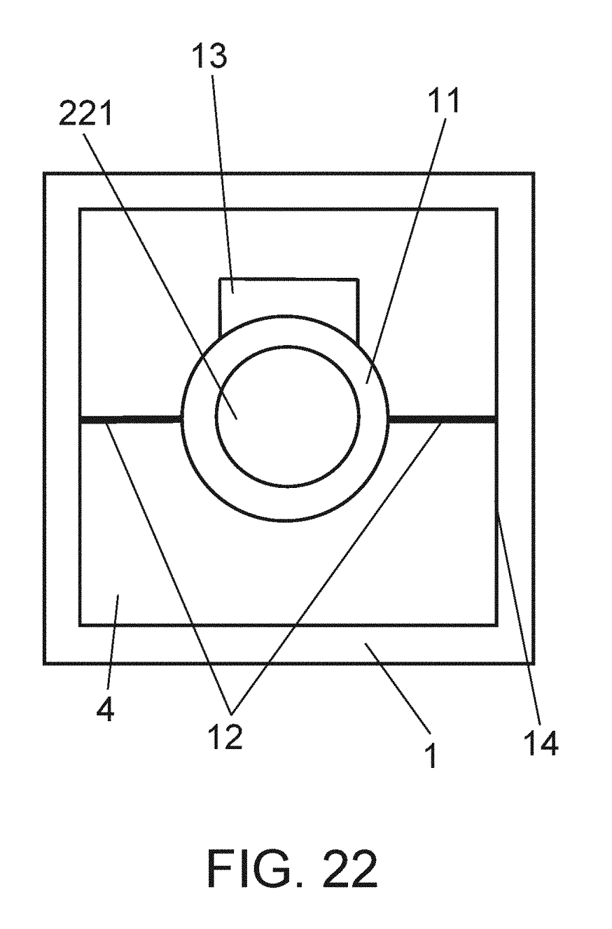

An alternative method of enhancing the cooling effect, as illustrated in FIG. 22, for example, is to wrap the beverage container 221 in a sleeve 11 made of an absorbent material, such as terry cloth, foam, sponge, neoprene, or other absorbent material, and wetting the sleeve 11 with an evaporative liquid, such as water. As a result, the beverage may be cooled more efficiently due to the combination of the conditioned air flow, the temperature of the conditioned air and evaporation of the evaporative liquid, where the conditioned air flow aids the evaporation of the evaporative liquid. This evaporative cooling cools the sleeve, which in turn cools the beverage container. The tether 12 is removably attached to an inside surface 14 of the outer box 1. The tether 12 may be attached to the inside surface 14 by hooks, adhesives, Velcro, or other suitable removably attaching mechanisms. The sleeve 11 is attached to the tether 12. The beverage container 221 is inserted into the sleeve 11. With the tether 12, the beverage container 221 in the sleeve 11 is suspended within the interior chamber 4, resulting in more surface area of the sleeve 11 having the conditioned air around the sleeve 11. The tether 11 is illustrated in FIG. 22 as having two sections; however, the tether 11 may be have one section or more than two sections. In such an embodiment where the tether 11 is has one section, the tether 11 will be sufficiently rigid and strong enough to suspend the beverage container 221 within the internal chamber 4. In such embodiments where the tether 11 has more than two sections, the additional sections may aid in the suspension of beverage container 221. The outer box 1 may further comprise a reservoir 13. The reservoir 13 is attached to the sleeve 11 and may contain an evaporative liquid. The reservoir 13 is configured to contact the sleeve 11 to provide the evaporative liquid by direct contact or through a membrane, capillary tube, wicking material or similar evaporative liquid transferring mechanism, to maintain the sleeve 11 moist as the evaporative liquid in the sleeve 11 evaporates. As the evaporative liquid in the sleeve 11 evaporates, the reservoir 13 contains additional evaporative liquid to keep the sleeve 11 moist with evaporative liquid. The outer box 1 may further comprise an opening to allow the user to add more evaporative liquid to the reservoir 13 or the sleeve 11 directly.

The interior chamber 4 can include gels or freezable materials so the user can freeze the entire unit by placing the interior chamber 4 in a freezer and then place it in vehicle to maintain the desired temperature by utilizing ventilation system. The interior chamber 4 can include warming materials so a user can heat it in an oven and then utilize the vehicle's warming vents to maintain the desired temperature. The interior chamber 4 can include a peltier chip that connects to the vehicle's cigarette lighter to expedite cooling and warming. The interior chamber 4 can include a temperature gauge so that the user is alerted once the interior chamber 4 reaches a desired temperature. The interior chamber 4 can include permanent microbeads or an area for holding removable microbeads that can be cooled and heated and then placed inside the interior chamber 4. The interior chamber 4 can include a fan for suctioning in or expelling out air.

The interior chamber 4 comprises an airflow intake opening that aligns with the airflow intake 2 of the outer box. The airflow intake opening on the interior chamber 4 may be smaller or larger than the airflow intake 2 on the outer box 1, or it can be the same size. The interior chamber 4 also comprises an air escape opening that aligns with the air escape 6 of the outer box 1. The air escape opening on the interior chamber 4 may be smaller or larger than the air escape 6 on the outer box 1, or the can be the same size.

The interior chamber 4 also comprises an access opening to allow access to the contents of the interior chamber 4. The access opening of the interior chamber 4 may be aligned with an opening of the outer box 1 to allow accessing the contents. In the alternative, the interior chamber 4 may have an opening with a cover, preferably constructed from the same material as the interior chamber 4, that is accessible when the interior chamber 4 removed from the outer box 1.

The vent caddy 100 may comprise a contents securing instrument 5 to secure the items placed in the interior chamber 4. The contents securing instrument 5 preferably will be positioned across the opening of the interior chamber 4 used to access contents of the interior chamber 4. The contents securing instrument 5 may also be positioned across the opening of the outer box 1 used for accessing the contents of the interior chamber 4. The contents securing instrument 5, may be in the form of an elastic or rigid band across the opening, door, lid, or other instrumentality, for holding items inside the interior chamber 4 and for preventing them from falling out. The contents securing instrument 5 may be perforated or have other openings in it, to allow air to pass through it, which is preferable when the opening to access the contents is the same as the air intake 2. The band can be attached to the surface of the interior chamber 4, or the outer box 1, surrounding the access opening. In the case of a door, it can be attached with screws, bolts, rivets, or another affixing method. It can swing open or slide left to right.

The contents securing instrument 5 can be either glued, adhered, staples, riveted, or melted to the outer box 1 or the interior chamber 4. The contents securing instrument 5 may simply be a band formed between two openings into a wall of the outer box 1 or the interior chamber 4.

The airflow escape 6 allows air to escape from the interior chamber 4. The airflow escape 6 can be located on any wall of the vent caddy 100.

The airflow escape 6 can be round, square, cylindrical, rectangular or any geometric shape for optimizing airflow and thermodynamics. The airflow escape 6 can be made of different types of foam or a combination of different types of foam, including; polyethylene foam, polypropylene foam, polystyrene foam, dry fast foam, closed cell foam, memory foam, rebond foam, supreem foam, latex rubber foam, high resilience foam, evlon foam, or high density foam. The airflow escape 6 can be made of different types of materials or a combination of different types of materials including; rubber, foam, plastic, plexiglass, wood, aluminum, Polyvinyl chloride, polypropylene, polyethylene, SAN resin, ceramics, metal, wood, plastic, composite, fiberglass, corrugated, graphite, plexiglass, among other materials. The airflow escape 6 can be either glued, adhered or melted to the outer box 1 or the interior chamber 4 or can be one solid part of the outer box 1 or the interior chamber 4.

The secondary chamber 7 is for keeping items such as chocolate or taffy from melting. The secondary chamber 7 provides easy access to items without having to open the outer box 1 or the interior chamber 4 of the vent caddy 100. As a tradeoff for the easy access and storage, the secondary chamber 7 does not provide the same level of cooling or heating as the interior chamber 4.

The secondary chamber 7 may be positioned on the top surface of the outer box 1 and may utilize the airflow from the air escape 6 from the outer box 1 for keeping cool various items (e.g., chocolate, taffy, caramel, or other similarly items) or keeping warm various items (e.g., warm croissants, baby bottles, etc.). The secondary chamber 7 is hollow and fills up with air from the airflow escape 6. Items may be placed inside the secondary chamber 7 to be cooled or warmed. The secondary chamber 7 may be fully open on top, or may include a removable cover, or a cover that slides or swings open. In one embodiment the bottom of the secondary chamber 7 serves as the top cover of the outer box 1. To provide better cooling or warming in the secondary chamber 7 the outer box 1 may not include insulation on top, or the interior chamber 4 may not have a top insulated cover.

The bottom of the secondary chamber 7 can be made of aluminum or another material that promotes temperature exchange from the airflow escape 6, or from the outer box 1. The other walls of the secondary chamber 7 may be insulated.

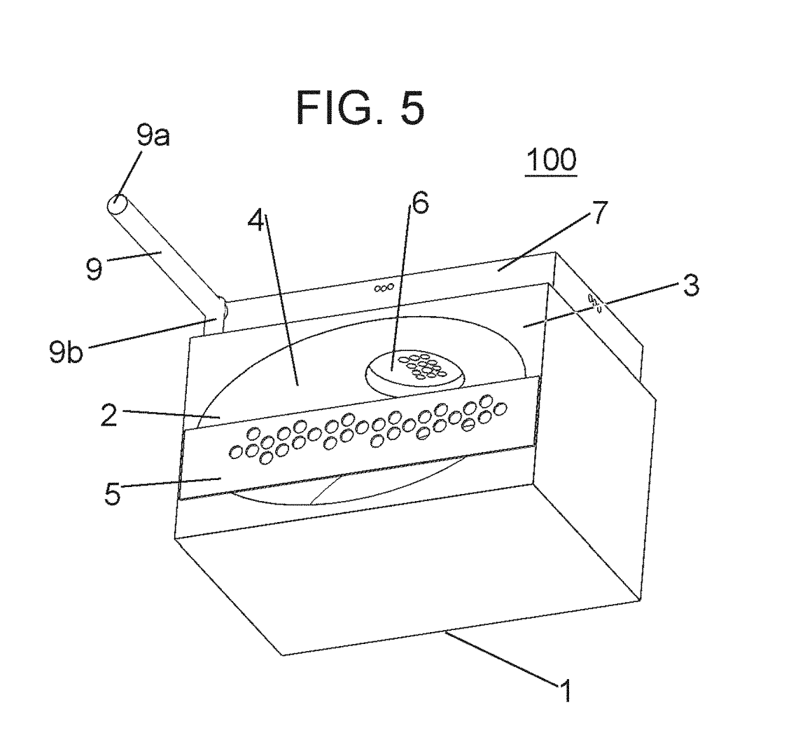

The secondary chamber 7 may include one or more beverage or other holders of various shapes. The holders may include openings, as shown for example in FIG. 5, to allow the air from inside the secondary chamber 7, or from the air escape 6, to come in direct contact with the beverage container or other items placed in the holder.

The secondary chamber 7 can be round, square, cylindrical, rectangular or any geometric shape for optimizing airflow and thermodynamics. The secondary chamber 7 can be made of different types of foam or a combination of different types of foam, including; polyethylene foam, polypropylene foam, polystyrene foam, dry fast foam, closed cell foam, memory foam, rebond foam, supreem foam, latex rubber foam, high resilience foam, evlon foam, or high density foam. The secondary chamber 7 can be made of different types of materials or a combination of different types of materials including; rubber, foam, plastic, plexiglass, wood, aluminum, Polyvinyl chloride, polypropylene, polyethylene, SAN resin, ceramics, metal, wood, plastic, composite, fiberglass, corrugated, graphite, plexiglass, among other materials. The secondary chamber 7 can be either glued, adhered or melted to the outer box 1 or can be one solid part of the outer box 1.

The vent caddy 100 can include a plurality of utility compartments 8 for holding gum, candy, napkins, utensils, and other convenience products. The plurality of utility compartments 8 can be in the form of trays, slots, and similar compartments.

The plurality of utility compartments 8 can be round, square, cylindrical, rectangular or any geometric shape for optimizing airflow and thermodynamics. The plurality of utility compartments 8 can be made of different types of foam or a combination of different types of foam, including; polyethylene foam, polypropylene foam, polystyrene foam, dry fast foam, closed cell foam, memory foam, rebond foam, supreem foam, latex rubber foam, high resilience foam, evlon foam, or high density foam. The plurality of utility compartments 8 can be made of different types of materials or a combination of different types of materials including; rubber, foam, plastic, plexiglass, wood, aluminum, Polyvinyl chloride, polypropylene, polyethylene, SAN resin, ceramics, metal, wood, plastic, composite, fiberglass, corrugated, graphite, plexiglass, among other materials. The plurality of utility compartments 8 can be either glued, adhered or melted to the outer box 1 or the interior chamber 4 or can be one solid part of the outer box 1 or the interior chamber 4.

The plurality of utility compartments 8 can include 1 or more cup holders. The top portion can include a cup holder for maintaining cool temperature for other drinks. The vent caddy 100 can include side storage compartment for holding convenience items, such as gum and candy. The vent caddy can include slots for holding convenience items, such as utensils and napkins. The back of vent caddy 100 may have slots for preventing the melting of gum and chocolate, as opposed to getting them ice cold.

The holding and positioning arm 9 may be used to securely support the entire vent caddy 100 unit and properly position it on the vehicle vent. The holding and positioning arm 9 may be attached with the anchor 9a. The anchor 9a may be any attaching instrumentality to attach the vent caddy 100 to the windshield or side window (e.g., a suction cup, adhesive, etc.), to headrest holes or headrest posts (e.g. clamps, Velcro, pins to insert inside the headrest socket, etc.), into the window slot (e.g., a plank that slides into the slot), into the ventilation duct itself, to the rearview mirror, or the to the sun-visor (e.g., clamps, Velcro straps, etc.). The holding and positioning arm 9 can include an adjustable rod 9b that can be adjusted lengthwise to allow for different positioning of the vent caddy 100, and to ensure tight fit against the surface with a vent by shortening the adjustable rod 9b to pull and press the outer box against the surface. The holding and positioning arm 9 or the adjustable rod 9a may also be flexible to allow for multiple adjustments.

The holding and positioning arm 9 may be adjustable and allow the user to position the entire unit in a desired position and location. The holding and positioning arm 9 can be made from flexible metal tubing.

The holding and positioning arm 9 can be connected to the any wall of the outer box 1, or within the interior chamber 4. Preferably the holding and positioning arm 9 is attached to the outer box 1 so as to allow the outer box 1 to rotate around the joint with the holding and positioning arm 9 and swing open so as to expose the opening used to access the contents of the interior chamber 4. The holding and positioning arm 9 may attach to the outer box 4 with hinges, ball joint, or other similar methods that allow the outer box 1 to move relative to the holding and positioning arm 9. The holding and positioning arm 9 may also detach from the vent caddy 100 to allow users to easily take with them on the go.

The vent caddy 100 may be held in place without the holding and positioning arm 9, for example with Velcro that would allow the user to pop on and off the vent caddy 100.

The holding and positioning arm 9, the anchor 9a and the adjustable rod 9b can be round, square, cylindrical, rectangular or any geometric shape for optimizing airflow and thermodynamics. The holding and positioning arm 9, the anchor 9a and the adjustable rod 9b preferably are metal or other structurally strong material. The holding and positioning arm 9, the anchor 9a and the adjustable rod 9b may also be made of different types of foam or a combination of different types of foam, including; polyethylene foam, polypropylene foam, polystyrene foam, dry fast foam, closed cell foam, memory foam, rebond foam, supreem foam, latex rubber foam, high resilience foam, evlon foam, or high density foam. The holding and positioning arm 9, the anchor 9a and the adjustable rod 9b can be made of different types of materials or a combination of different types of materials including; rubber, foam, plastic, plexiglass, wood, aluminum, Polyvinyl chloride, polypropylene, polyethylene, SAN resin, ceramics, metal, wood, plastic, composite, fiberglass, corrugated, graphite, plexiglass, among other materials. The holding and positioning arm 9 can be either glued, adhered or melted to the outer box 1 or can be one solid part of the outer box 1.

The covering 10 is utilized for aesthetics, insulation and structural integrity. The covering 10 can be made from different types of fabrics or a combination of fabrics, including; Aba, Acrilan fabric, Acrylic fiber, Aertex, Airdura, Airguard, Alengon lace, Angora, Antique satin, Argentan lace, Argentella lace, Armenian needlelace, Baize, Ballistic nylon, Bamboo, Ban-Lon, Barathea, Barkcloth, Batik, Batiste, Battenberg lace, Bedford cord, Benaras, Bengaline silk, Beta cloth, Bird's-Eye Weave, Bobbinet, Boiled wool, Bombazine, Bouclé, Braid, Brilliantine, Broadcloth, Brocade, Broderie Anglaise, Buckram, Bunting, Burano lace, Buratto lace, Burlap, C change, Calico, Cambric, Camel's hair, Camlet, Canvas, Capilene, Carbon fiber, Carrickmacross lace, Casement, Cashmere, Cavalry twill, Cedar bark, Challis, Chambray, Chantilly lace, Char cloth, Charmeuse, Charvet, Cheesecloth, Chenille, Chiengora, Chiffon, Chino, Chintz, Cloqué, Cloth of gold, Conductive, Coolmax, Coir, Cordura, Corduroy, Cotton duck, Coutel, Crape, Crêpe-back satin, Crêpe de Chine, Cretonne, Crimplene, Crinoline, Crochet, Cotton, Damask, Darlexx, Dazzle, Delaine wool, Denim, Dimity, Dobby, Doeskin, Donegal tweed, Dotted Swiss, Double cloth, Double knitting, Double weave, Dowlas, Drill, Drugget, Duck, Dupioni silk, Dyneema, Eyelet, Egyptian cotton, E-textiles, Faile, Faux fur, Felt, Filet/Lacis lace, Fishnet, Flannel, Flannelette, Fleece, Foulard, Fustian, Gabardine, Gannex, Gauze, Gazar, Georgette, Ghalamkar, Gingham, Gore-Tex, Grenadine, Grenfell Cloth, Grosgrain, Habutai, Halas lace, Haircloth, Harris Tweed, Heather knit, Hemp, Herringbone, Himroo, Hodden, Holland cloth, Hollie Point lace, Hopsack, Houndstooth check, Indian cotton, Intarsia, Interlock, Irish linen, Jacquard, Jacquard knit, Jamdani, Jersey, Jute, Jaconet, Kemp, Kenmare Lace, Kerseymere, Kevlar, Khādī, Khaki, Khaki drill, Kente cloth, Kincob, Knit, Lace, Lambswool, Lame, Lampas, Lantana, Lawn cloth, Lazzer, Leather, Leatherette, Leno, Limerick lace, Linen, Linsey-woolsey, Loden, Longcloth, Loop knit, Lumalive, Lycra knit, Machine knitting, Mackinaw, Madapolam, Madras, Malimo, Marquisette, Matelassé, Melton, Merino, Mesh, Microfibre, Milliskin, Mockado, Mohair, Moire, Moleskin, Monk's cloth, Moquette, Mouflon, Mousseline, Muslin, Natural fiber, Neoprene, Nomex, Nylon, Oilskin, Organdy, Organza, Osnaburg, Ottoman, Oxford, Omran, Paduasoy, Paisley, Panné, velvet, Peau de Soie, Percale, Piqué, Plissé, Plush, Point de France lace, Point de Gaze lace, Point de Venise lace, Pointelle, Polar fleece, Pongee, Poplin, Punto in Aria lace, Polyester, Qiviut, Quilting, Raschel knit, Rakematiz, Rayadillo, Rayon, Raw silk, Rep, Reticella lace, Ribbon lace, Rib knit, Rib weave, Rinzu, Ripstop, Ripstop nylon, Russell cord, Saga Nishiki, Sailcloth, Samite, Sateen, Satin, Saye, Scarlet, Scrim, Seersucker, Sequin, Serge, Shantung, Sharkskin, Shot silk, Silk, Silk Noil, Silnylon, Smartwool, Songket, Spandex, Stockinette, Stub-tex, Stuff, Suede, Surah, SympaTex, Taffeta, Tais, Tammana, Tambour lace, Tapestry, Tartan, Teneriffe lace, Terrycloth, Terry velour, Ticking, Toile, Tricot knit, Tulle netting, Tussar silk, Tweed, Twill, terrywool, terrycotton, terrysilk, Ultrasuede, Velour, Velours du Kasaï, Velvet, Velveteen, Venetian Lace, Venetian Wool, Ventile, Vinyl coated polyester (PVC), Viyella, Voile, Vintage, Wadmal, Whipcord, Wigan, Windstopper, Worcester, Worsted wool, Wool, Youghal lace, Yarn, Zephyr, Zibeline, or Zorbeez. The covering 10 can be made from different types of textiles or a combination of textiles, including animal textile, plant textile, synthetic textile, or mineral textiles—such as aramid, olefin, ingeo, or lurex.

An illustrative application of one embodiment of the present invention: the user attaches a suction cup to the windshield and then positions the vent caddy 100 with the use of the holding and positioning arm 9 in front of the desired duct. The user then opens the vent caddy 100 by swiveling it open via the “holding arm's joint”—where the holding and positioning arm 9 and outer box 1 meet. The user places a beverage inside and then swivels the vent caddy 100 so the air intake 2 is directly in front of the duct. The user turns on the vehicle's air ventilation system to hot or cold, and waits for the vent caddy's temperature gauge to reach its desired temperature. After the desired drinking temperature has been reached, the user can swivel open the vent caddy 100 and remove the drink.

While the invention has been described with reference to exemplary embodiments, it will be understood by those skilled in the art that various changes, omissions, and/or additions may be made and equivalents may be substituted for elements thereof without departing from the spirit and scope of the invention. In addition, many modifications may be made to adapt a particular situation or material to the teachings of the invention without departing from the scope thereof. Therefore, it is intended that the invention not be limited to the particular embodiments disclosed as the best mode contemplated for carrying out this invention, but that the invention will include all embodiments falling within the scope of the appended claims. Moreover, unless specifically stated any use of the terms first, second, etc. do not denote any order or importance, but rather the terms first, second, etc. are used to distinguish one element from another.

We claim:

1. A vent caddy for securely holding an item that a user desires to have an ambient temperature around the item be regulated by utilizing a vehicle's ventilation system, the vent caddy comprising:
an outer box; wherein the outer box comprises an interior chamber;
an airflow intake;
wherein the airflow intake is in communication with the vehicle's ventilation system;
wherein the airflow intake is in communication with the interior chamber;
wherein conditioned air flows from the vehicle's ventilation system through the airflow intake to the interior chamber;
wherein the interior chamber is configured to securely hold the items; and,
wherein the conditioned air regulates the ambient air surrounding the item.

2. The vent caddy of claim 1 further comprising a dashboard seal, wherein the dashboard seal forms a seal between the airflow intake and the vehicle's ventilation system.

3. The vent caddy of claim 1 further comprising a contents securing instrument.

4. The vent caddy of claim 1 further comprising an airflow escape, wherein the airflow escape is in communication with the interior chamber; and, wherein the conditioned air flows from the interior chamber through the airflow escape.

5. The vent caddy of claim 4 further comprising a secondary chamber.

6. The vent caddy of claim 5, wherein the secondary chamber comprises an aperture;
wherein the aperture is in communication with the airflow escape; and, wherein the conditioned air flows into the secondary chamber.

7. The vent caddy of claim 1 further comprising a covering.

8. The vent caddy of claim 1 further comprising a plurality of utility compartments;

9. The vent caddy of claim 1 further comprising a holding and positioning arm; wherein the holding and positioning arm comprises:
an anchor; and,
an adjustable rod.

10. The vent caddy of claim 1, wherein the interior chamber is integrally formed with the outer box.

11. The vent caddy of claim 1, wherein the interior chamber is removably inserted into the outer box.

12. The vent caddy of claim 1, wherein the outer box further comprises:
a tether; and,
a sleeve;
wherein the tether is removably attached to an inside surface of the outer box; and,
wherein the sleeve is attached to the tether.

13. The vent caddy of claim 12, wherein the outer box further comprises a reservoir.
